(19) United States
(12) Patent Application Publication
(10) Pub. No.: US 2014/0345119 A1
(43) Pub. Date: Nov. 27, 2014

(54) Method and Device for Producing Flat Coils

(71) Applicants: Jan Tremel, Zapfendorf (DE); Florian Risch, Nurnberg (DE)

(72) Inventors: Jan Tremel, Zapfendorf (DE); Florian Risch, Nurnberg (DE)

(73) Assignee: FRIEDRICH-ALEXANDER-UNIVERSITÄT ERLANGEN-NÜRNBERG, Erlangen (DE)

(21) Appl. No.: 14/239,329

(22) PCT Filed: Aug. 7, 2012
(86) PCT No.: PCT/EP2012/003368

§ 371 Date: Jul. 9, 2014

(30) Foreign Application Priority Data
Aug. 19, 2011 (DE) 10 2011 110 652.2

(51) Int. Cl. H01F 41/04

(52) U.S. Cl. CPC H01F 41/04
USPC 29/605; 29/745

(57) ABSTRACT

The invention relates to a method for producing substantially two-dimensional flat coils (28), wherein at least two cover plates (2, 3) that each have a cover surface (20) and a former (4) having a former surface (21) that is smaller than the cover surfaces are provided, wherein the former is releasably clamped between the two cover plates, such that at least some sections of lateral support surfaces (10) are formed by projecting sections (9) of the cover plates, wherein a coil conductor (25) for the geometry of the flat coil (28) is wound along the circumference of the former between the cover plates, and wherein the wound coil conductors (25) are fixed locally relative to one another through cut-outs (16) in at least one of the cover plates. The invention further relates to a corresponding winding device (1, 11, 22).

The invention relates to a method and to a device for producing substantially two-dimensional flat coils of different geometries. Flat coils of this kind are required for contactless inductive energy transfer both on the transmitter side and on the receiver side. In particular, flat coils of this kind are required for innovative concepts to form inductive road systems. In this case, flat coils of corresponding geometry, which generate directed magnetic fields, are laid at suitable points in the carriageway. Electrically operated vehicles which are located above said flat coils can inductively absorb the energy which is required for driving when standing or moving over the flat coils which are laid in the ground.

Inductive road systems are currently the subject of intensive research. The research is directed, in particular, at increasing the transmission powers of the systems and increasing the required minimum spacing between the transmitting coil and receiving coil within which economic energy transfer is still possible. Transmission powers in the kW range are required for inductive road systems. A minimum spacing which is required for energy transfer in the decimeter range would be desirable on account of the necessary ground clearance of the vehicles.

Flat coils which have a relatively low volume are required on account of the geometric and physical prerequisites of the contactless energy transfer system. Secondly, flat coils provide the option of creating a directed magnetic field with a relatively large and directed extent, wherein losses due to stray fields can be kept low.

Contactless energy transfer in electrically operated vehicles with flat coils which are embedded in the carriageway has the advantage over cable-bound solutions of a high degree of charging convenience, a high degree of reliability due to the lack of parts which are subject to wear, an increased level of electrical safety for users, esthetic advantages in historical towns, protection of the infrastructure against vandalism and relatively low servicing costs. Energy transfer via inductive road systems additionally allows energy to be continuously supplied from a primary structure in a carriageway to a vehicle not only when said vehicle is stationary, but also when said vehicle is moving. Therefore, electrically operated vehicles which can eliminate the problem of battery-related range limitation with a minimal and cost-effective energy store can be realized.

For comprehensive introduction of inductive road systems into future electric mobility markets, both product improvements and process innovations are required. The latter are particularly important in order to ensure cost-effective and therefore comprehensive introduction of charging infrastructures in an accelerated manner.

The design of known systems for contactless energy transfer in electrically operated vehicles when the vehicle is stationary and when the vehicle is moving shows that efficient integration of the required flat coils in respect of production is not yet ensured on account of the difficulty in handling the floppy materials. Therefore, in accordance with WO 2010/090539 A1 and DE 103 12 284 B4, grooves are required in the coil carrier or shaped plastic parts in the requisite flat coils for precise holding and spacing of the individual coil conductors, this leading to complicated laying of the flat coils.

In order to produce a plurality of air-core coils which are connected to one another, DE 40 13 958 A1 discloses a winding device, wherein a winding core is advanced through a first lateral support in order to position the winding core between the first lateral support and a second lateral support. A pocket is provided on a lateral support in order to hold the ready-wound air-core coil when the winding core is pushed back. As a result, a plurality of air-core coils can be wound in succession, without severing winding material of a preceding air-core coil. Disadvantageously, the required tool is complex and expensive and not economical, in particular for large flat coils of relatively simple geometry.

DE 101 60 390 A1 proposes a method for producing a small flat coil for contactless transponders in smartcards, stickers, tickets or vouchers. The winding tool comprises a winding core plate and a winding plate which are placed one on the other with a spacing of a winding wire between them by means of spacers which are firmly mounted in the winding core plate. Individual turns with varied geometries can be generated by means of axially displaceable winding cores, which are in the form of pins, during coil winding. Disadvantageously, creating the geometry by means of individual displaceable winding cores does not have the requisite process reliability for large flat coils.

Finally, EP 2 226 819 A1 proposes the production of a spiral flat coil, wherein a winding wire and an insulating wire are jointly wound about a shaft onto a disk in a spiral manner. In this case, the beginning and the end of the winding path are axially offset in relation to one another. The described method does not permit the production of flat coils of different geometries. Disadvantageously, the flat coils produced in this way are not planar either.

The object of the invention is to simplify the production of substantially two-dimensional flat coils in respect of manufacture, wherein, in particular, laying aids, such as shaped parts, are intended to be dispensed with, and wherein different geometries of the flat coils can be realized in a simple and cost-effective manner using a simple winding tool.

In order to achieve the object, the invention specifies a method for producing substantially two-dimensional flat coils, wherein at least two covering plates, which have a respective covering surface, and a separate former with a former surface which is smaller than the covering surfaces are provided, wherein the former is releasably clamped between the two covering plates, so that lateral supporting surfaces are formed at least in sections by projecting sections of the covering plates, wherein a coil conductor is wound along the circumference of the former between the covering plates to form the geometry of the flat coil, and wherein the wound coil conductors are fixed locally relative to one another through cutouts in at least one of the covering plates.

In this case, the invention is based on the idea of producing flat coils in as flexible a manner as possible in respect of different geometries. In this case, the production method should be as simple and easy to integrate into processes as possible.

By virtue of the provision of a separate former, which is clamped in a modular manner between two covering plates, the system is extremely flexible in respect of the shape of the flat coil. Depending on the former chosen, a flat coil can be produced which has a square, rectangular, round, oval, triangular, polygonal or other shape in respect of its circumferential profile. To this end, the respective former has to be adapted only in respect of its shape or in respect of its circumferential profile. The same applies in respect of the thickness and the shape of the coil conductor. For coil conductors of different thicknesses, it is only necessary to provide or use formers of different thicknesses.

A high process speed is possible on account of the coil conductor being wound in a limited space between the covering plates which act as lateral supporting walls. In this case, winding can be performed in a simple manner by rotation of the coil support, wherein the coil conductor is gradually wound along the circumference of the former.

The invention further provides the option of parallelizing production since a plurality of coil support arrangements, each comprising covering plates and former, can be jointly rotated on a shaft with identical or different formers. A plurality of flat coils, which can additionally have differing geometries, are produced at the same time during one process step in this case.

Integration of a wire tension control means, which may be necessary, is likewise possible without problems on account of the simple construction of the winding device. A wire tension control means of this kind is advisable, in particular, in the case of complex geometries or edge structures of the respectively used former.

A prestress, which may lead to a greater mechanical stability and therefore a longer service life, can also be realized in the flat coil by adjusting the wire tension during winding. In addition, winding under wire tension increases the process reliability since, as a result, it is possible to ensure that each winding path lies directly on the previous winding path.

The shape of the wound flat coil is additionally stabilized by fixing the wound coil conductors to one another. To this end, there are cutouts in at least one of the covering plates which form a lateral access point to the winding structure. The windings of the flat coil can be locally fixed to one another by adhesive bonding, potting or by thermal treatment via these cutouts. In addition, it is possible to monitor the winding profile for homogeneity during the process via the provided cutouts.

Releasably clamping the covering plates to one another advantageously makes it possible to also remove the flat coil from the device in a simple manner at the end of the production process. The former, including the wound flat coil, is released by releasing the clamping. The flat coil can then be axially removed or radially ejected from the former without problems. It is also possible to hold the flat coil, including former, in a manner which is stable during transportation. In this case, provision can also be made for the flat coil, including former, to be laid.

However, it is not necessary to remove the flat coil, with or without former, from the covering plates at the end of the winding process. Rather, it is likewise readily possible to lay the flat coil, including the covering plates, at the site of use. To this end, the covering plates can have, for example, a corresponding shaping for installation, in particular they can be correspondingly deformed in three dimensions. In addition, the covering plates can then be used to install additional auxiliary components, such as ferrite cores, electronic components, electrical circuits etc. for example.

In order to clamp the covering plates with an interposed former and also to eject the former, different methods can be provided in principle, in particular pneumatic, hydraulic, mechanical or electrical closure, opening and/or ejection mechanisms can be used for this purpose.

The invention provides a high level of process reliability when realizing the precise coil arrangement and the spacings between the coil conductors, wherein complex and expensive shaped plastic parts are avoided. To this end, the free winding space between the covering plates preferably is equal to the thickness of the coil conductor which is to be wound. This is achieved by the axial thickness of the former being selected in accordance with the diameter of the coil conductor which is to be wound. In this respect, winding can be performed with an increased level of prestress, without there being the risk of coil conductors intersecting.

In principle, the former will be a flat former of which the height or thickness is substantially smaller than the diameter thereof, in other words, a flat former is a substantially planar former. Therefore, flat coils will be wound, the axial thickness of said flat coils, in particular the diameter of an individual coil conductor, being small in relation to the radial extent thereof. The area around which the windings of a flat coil of this kind run will be prespecified by the former.

In a further preferred refinement, the covering plates and the former are mounted by means of a respective central opening in a shaft and are clamped to one another in the axial direction on the shaft. Only one common clamping device is required for clamping purposes. All parts, that is to say the covering plates and the former, are centered in the process directly by being pushed onto the provided shaft. Corresponding position control is not required. The coil supports are then further advantageously driven by means of the shaft in order to wind the flat coils. In this case, the respective central openings are provided, for example, as polygons, so that there is an interlocking connection with the shaft. It goes without saying that other options for forming a rotationally fixed connection can also be realized.

In general, it is also feasible for the coil support comprising covering plates and former to remain stationary during winding and for the coil conductor to be routed around the coil support for winding purposes. However, rotation of the coil support can be realized in a significantly more simple and cost-effective manner in respect of processing. In particular, complicated supply of wires is not necessary.

In order to secure the coil conductor when winding is started, one end of the coil conductor is advantageously routed from the inside to the outside through one of the covering plates through an opening before the former is clamped. Since the corresponding covering plate is freely accessible at the beginning of the process, it is possible to route said end through in such a way without problems. After the second covering plate is fitted, the end of the coil conductor is bent at a right angle, as a result of which the coil conductor is already fixed, as such, before the winding process starts. In addition, a suitable clamping device, which firmly holds the end of the coil conductor, can be mounted on the outside of the covering plate.

The described winding method also permits simple integration of additional wires, such as, in particular, blind wires as spacers or for realizing polyphase structures. If a blind wire is used as a spacer, a defined spacing between adjacent coil conductors can be achieved without complex shaped parts which have been required to date. In this case, coil conductor and blind wire are jointly wound such that they lie radially one on the other, wherein coil conductor and blind wire alternate in the radial direction in the flat coil. The blind wire can be composed of plastic, it can be provided as a cable comprising a conductor and an insulating sleeve or as an uninsulated conductor. The additional incorporation by winding of a nonmetallic spacer can be used, in particular, in order to improve heat dissipation during the later operation of the flat coil. The power of the flat coil which can be emitted may be increased as a result of this.

The abovementioned parallelization of the production method is preferably realized by a plurality of formers being clamped to one another between two covering plates and in a manner separated from one another by in each case one covering plate, so that a sequence comprising former and covering plate is produced between two terminating covering plates. The resulting structure can be clamped by means of a common clamping device and then also be driven jointly. The in this case several flat coils which are jointly wound can be ejected at the same time by releasing the clamping connection. To this end, after the clamping connection is released, a common shaft or a common spindle is, for example, withdrawn from the respectively present central openings in formers and covering plates or the formers and covering plates, for example, are removed or ejected from a common shaft or a common spindle after the clamping connection is released.

In an advantageous variant, at least one additional component, in particular a ferrite body, an electronic component and/or an electrical circuit, is inserted into at least one material cutout in at least one of the covering plates. This variant is suitable for integrating electronics or for field shaping if the flat coil is laid together with a covering plate or with the two covering plates at the site of use.

In order to lay the flat coil jointly with the covering plates, it is further expedient for the covering plates to be permanently fixed to one another by a number of fastening elements. These fastening elements can, in particular, additionally be used to fix the flat coil, in particular if said flat coil has a complex geometry.

In a preferred development, a further coil conductor is wound at least around some of the fastening elements. As a result, it is possible to lay additional coils which remain in the product and which serve, for example, to apply a local opposing field.

In a further advantageous variant embodiment, the cross section of the coil conductor and/or of the further coil conductor is locally deformed before the winding operation or during the winding operation. As a result, differing winding profiles can be achieved which have, for example, locally varying winding spacings. In particular, a narrow packing density can be created at the radii and a larger spacing between the windings can be created at the parallels in the winding profile of the flat coil.

When one covering plate or the two covering plates are also installed, the coil conductor and/or the further coil conductor can furthermore expediently be laid in grooves in the covering plate which is also installed, and be fixed there, in particular by an encapsulation or adhesive compound.

The variant embodiments described here for the coil conductor analogously also apply for the further coil conductor which is wound around the fastening elements.

The stated object is further achieved according to the invention by a device for winding flat coils, which device comprises at least two covering plates having a respective covering surface, a former with a former surface which is smaller than the covering surface, and a clamping device for clamping the former between the two covering plates, wherein local cutouts are made in at least one of the covering plates.

Further advantageous refinements can be found in the dependent claims which are directed at the device. In this case, the advantages cited in respect of the method can be analogously transferred to the device.

In a further preferred refinement of the device, the covering plates and/or the formers are each provided with an anti-adhesion coating for the coil conductor which is to be wound or for the material which locally fixes the windings to one another. As a result, the process speed can be increased since the coil conductor which is to be wound has a reduced friction in relation to the covering plates. If the former has an anti-adhesion coating, the complete flat coil can be separated from the former in a simpler manner.

The invention is not restricted in respect of the configurations of the coil conductor. It is advisable to use stranded conductors for flat coils which are provided for transmitting powers in the kW range. As compared to a solid wire conductor, the so-called skin effect is avoided in a stranded conductor, so that higher frequencies and therefore higher powers can be transmitted in an inductive manner.

At least one of the covering plates preferably comprises at least one material cutout for holding at least one additional component, in particular a ferrite core, an electronic component and/or an electrical circuit. Furthermore, when laying the product with the covering plates, provision is expediently made for the covering plates to be permanently fixed by means of a number of fastening elements. In this case, at least some of the fastening elements are advantageously designed to be wound with a further coil conductor, in particular as rivets or as fastening pins. For permanent fixing to a covering plate, provision is expediently made for grooves for holding the coil conductor to be made in one of the covering plates. The coil conductor is fixed in said grooves, in particular by means of an encapsulation compound or an adhesive compound.

Exemplary embodiments of the invention will be explained in greater detail with reference to a drawing, in which:

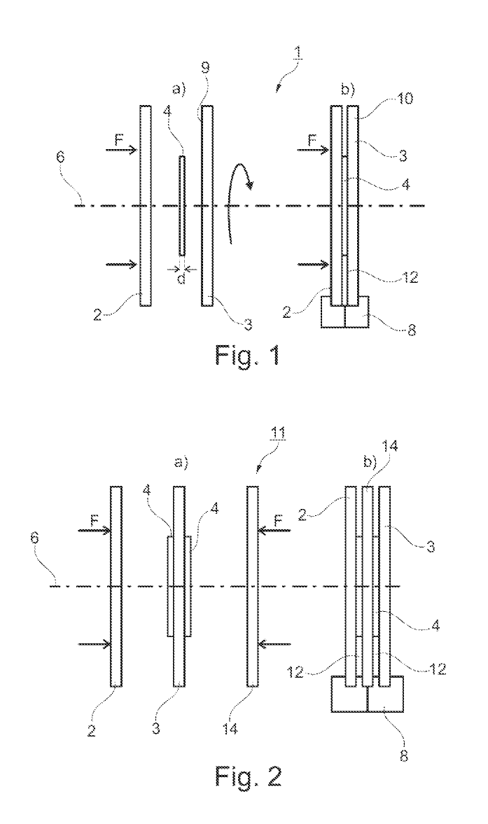

FIG. 1: schematically shows a side view of an individual winding device in an open state and in a closed state,

FIG. 2: schematically shows a side view of a winding device with parallel coil supports in an open state and in a closed state,

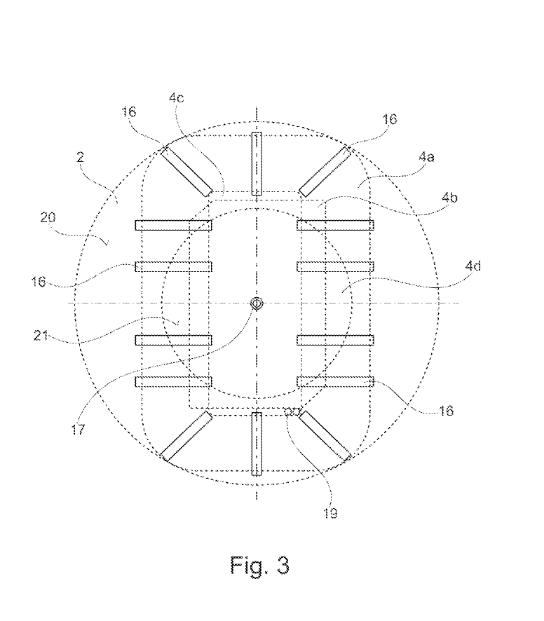

FIG. 3: shows a model for producing covering plates and formers,

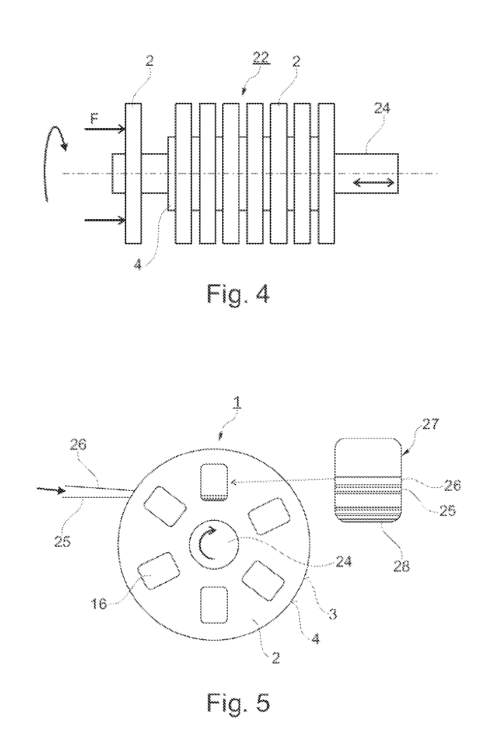

FIG. 4: schematically shows a side view of a winding device having a plurality of coil supports which are pushed onto a shaft,

FIG. 5: schematically shows a plan view of a winding device with cutouts for fixing and checking the winding profile,

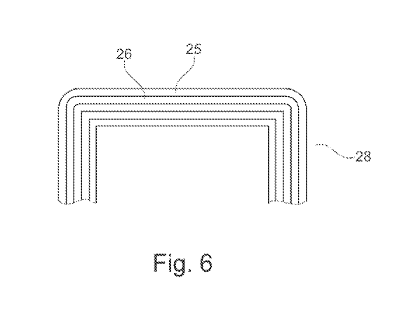

FIG. 6: shows a partial view of a wound flat coil,

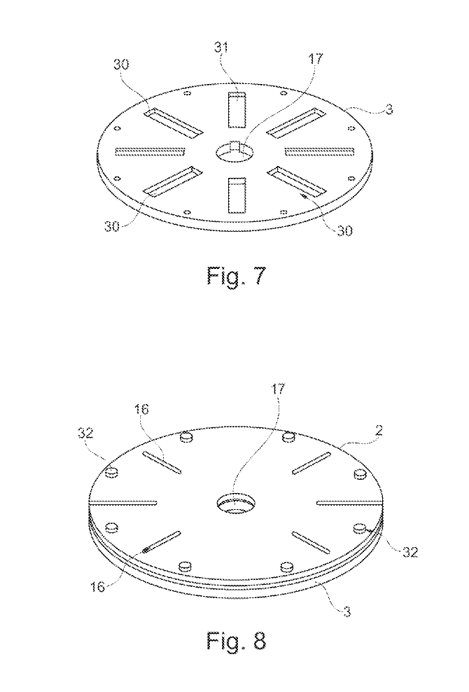

FIG. 7: shows a top view of a covering plate of a winding device,

FIG. 8: shows a top view of a winding device which is intended to be laid with the covering plates at the site of use,

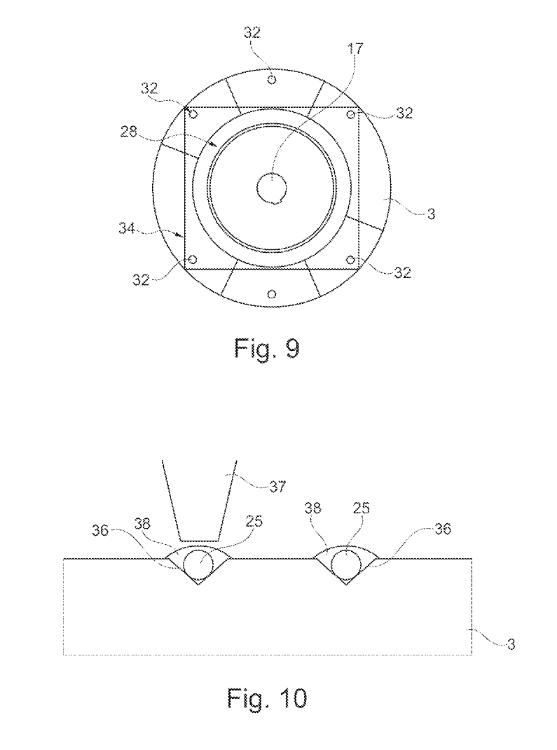

FIG. 9: shows a top view of a covering plate of a winding device with an additional coil, and

FIG. 10: shows a cross section through a covering plate with grooves, in which the coil conductor is laid and fixed.

FIG. 1 schematically shows a side view of a flexible winding device 1 for winding flat coils of different geometries. The winding device 1 is illustrated in an open state in accordance with FIG. 1a) and in a closed state in accordance with FIG. 1b). The winding device 1 comprises a first covering plate 2 and a second covering plate 3, it being possible for a separate exchangeable former 4 to be held between said covering plates. The winding axis 6, about which a coil conductor is wound in order to form the flat coil which is to be produced, is further shown in FIG. 1. Winding is performed along the circumference of the former 4 which is shown as a sketched rectangle with a thickness d in side view. As shown, the former 4 has a cross-sectional area perpendicular to the plane of the drawing, said cross-sectional area being reduced in comparison to the cross-sectional areas of the covering plates 2, 3. This results in projecting sections 9 on the respective inner face of the covering plates 2, 3, said projecting sections not being covered by the former 4.

Before the winding method begins, the two covering plates 2, 3 are clamped to one another, with the interposition of the former 4, by means of a clamping device 8 which is schematically illustrated. The resulting closed state is shown in FIG. 1b). This results in a winding space 12 around the former 4 between the projecting sections 9 of the covering plates 2, 3, wherein the projecting sections 9 act as lateral supporting surfaces 10. A flat coil can be wound along the circumference of the former 4, with the radial supply of a coil conductor, by virtue of rotation of the shown device 1 about the winding axis 6. In this case, the thickness d of the former 4 is selected so as to correspond to the diameter of the coil conductor which is to be wound, so that it is not possible for individual winding paths to intersect during winding. Winding can be performed under prestress of the coil conductor, this leading to a high degree of process reliability.

A flat coil of a different geometry can be produced by exchanging the former 4. To this end, the formers 4 each have different cross-sectional shapes and are shaped, for example, in a round, rectangular, oval etc. manner.

FIG. 2 once again schematically shows a side view of a winding device 11 for producing a plurality of flat coils in parallel. Once again, the open state of the device 11 is shown in FIG. 2a), and the closed state of the device 11 is shown in FIG. 2b) in this case.

In addition to the abovementioned covering plates 2, 3, the winding device 11 comprises a further, third covering plate 14. A former 4 is inserted between two of the covering plates 2, 3 and, respectively, 3, 14 in each case. In the closed state according to FIG. 2b), the three covering plates 2, 3, 14 and the two formers 4 are jointly clamped in relation to one another by means of a clamping device 8. This results in two winding spaces 12, wherein the shape of the flat coil which is wound in the respective winding space is given by the former 4 which is used in each case.

If identical formers 4 are used, two identical flat coils can be wound in parallel. If the formers 4 have different cross-sectional shapes or circumferential shapes, two different flat coils are wound in parallel. Two flat coils of different thicknesses can be produced in parallel with different coil conductors by using formers 4 which differ in respect of their thickness d.

FIG. 3 shows a former pattern which shows the different options for shaping or producing covering plates 2, 3 or formers 4.

By way of example, a covering plate 2 as shown in side view in FIGS. 1 and 2 is given by the outer circle of the former pattern. By way of example, cutouts 16 which later allow access to the winding profile can, as shown, be punched out from the covering plate 2. It is possible to locally fix the individual turns to one another in the wound flat coil via these cutouts 16. To this end, a fixing means, for example, is inserted and cured via the cutouts 16 after winding is complete. A series of cutouts 16 are shown in the former pattern according to FIG. 3, said cutouts being able to allow, in particular, access to a substantially rectangular coil.

A central opening 17, which is intended both for the covering plate 2 and also for formers 4 which are further produced, is provided in the center of the former pattern according to FIG. 3. The formers 4 shown are a rectangular former 4a), a rectangular former with two beveled corners 4b), a smaller rectangular former 4c), and a round former 4d).

The former pattern according to FIG. 3 shows the simplicity of the device which is specified for winding. The shape of the former 4 is smoothly adjusted in each case in order to produce flat coils of different geometries. If a coil conductor of a different diameter is wound, the former 4 is produced from a material of correspondingly changed thickness. FIG. 3 also shows that the covering surface 20 of the covering plate 2 is larger than the former surface 21 of the former 4, so that lateral supporting surfaces 10 according to FIGS. 1 and 2 are produced around the inserted former 4 between two adjacent covering plates 2, 3. Recesses 19 are shown in the interior of the former pattern. At least one end of the coil conductor which is to be wound can be routed out via said recesses 19 before the former 4 is clamped, so that the end is fixed before winding begins or will be fixed to the outer face.

FIG. 4 shows a side view of a winding device 22 which allows a total of seven flat coils to be wound in parallel. A total of eight covering plates 2 are pushed onto a shaft 24 in the axial direction, wherein a respective former 4 is located between adjacent covering plates 2 in each case.

It is clear that a plurality of flat coils can be produced in parallel, possibly even with different geometries, by driving the common shaft 24 in a single parallel process step. In this case, the flat coils which are produced in parallel may differ in respect of their shape and/or in respect of their thicknesses, wherein different formers 4 are inserted between the respective covering plates 2. The modular design of the device 22 makes it possible to match the winding tool to the desired delivery quantities of flat coils in a simple manner. At the same time, the individual components are centered by means of being axially pushed onto a common shaft 24. The stacked components can be clamped by a common clamping device, and opened. Pulling out the common shaft 24 also makes it possible to eject the complete flat coils in parallel in a single process step.

FIG. 5 shows a plan view of a winding device 1 according to FIG. 1 for winding a flat coil. The covering plates 2, 3 and the former 4 are pushed axially onto a shaft 24 via a central opening. Only the first covering plate 2 is shown in FIG. 5. The covering plate 2 has a total of six cutouts 16 which allow access to the winding profile of the flat coil. After winding is complete, a fixing means is inserted and cured via these cutouts 16, so that the flat coil is locally stabilized.

In order to wind the flat coil, the shaft 24, together with the mounted covering plates 2, 3, including the former 4, rotates in the shown direction. A coil conductor 25 and a blind wire 26 are jointly supplied from the radial direction. A flat coil, of which the shape is prespecified by the circumferential shape of the former 4, is produced over the circumference of the former 4.

The flat coil 28 has, in accordance with the winding profile 27, an alternating sequence of coil conductor 25 and blind wire 26 in the radial direction. The coil conductor 25 is provided, for example, as a stranded conductor with an insulating sleeve. The blind wire 26 provided is, for example, a nonmetallic spacer. The blind wire 26 allows both the spacing between adjacent coil conductors 25 to be defined and also allows improved heat dissipation from the resulting flat coil 28 during operation.

FIG. 6 shows the design of a complete flat coil 28 in a highly schematic manner. The shown flat coil 28 is produced by jointly winding a coil conductor 25 and a blind wire 26 which is composed of plastic. Coil conductor 25 and blind wire 26 alternate in the radial direction of the flat coil 28.

The shown flat coil 28 has a plurality of winding convolutions and is produced in rectangular form.

FIG. 7 shows a top view of a lower covering plate 3 of a winding device. The complete product, that is to say the produced flat coil, is laid together with the illustrated lower covering plate 3 at the site of use in this case. The lower covering plate 3 has a number of material cutouts 30. Additional components 31 are inserted into these “mold cavities”. Additional components of this kind are, for example, electronic components, electrical circuits etc., or magnetic elements such as ferrite cores. The latter serve to shape the magnetic field at the site of use of the flat coil.

FIG. 8 shows a completely assembled product with the two covering plates 2, 3 and a flat coil which is wound around the held former. The product is completely installed at the site of use as illustrated. The cutouts 16 which are provided for fixing the windings of the flat coil are clearly visible. In order to permanently fix the two covering plates 2, 3 to one another, fastening elements 32 are provided, said fastening elements being in the form of pins and/or rivets which pass through the covering plates 2, 3.

According to FIG. 9, which shows the lower covering plate 3 of the product which is shown in FIG. 8, the flat coil 28 is wound in the interior. In addition, a further coil conductor 34 in the form of a rectangular coil is wound around some of the fastening elements 32 in order to build up an opposing field.

FIG. 10 shows a cross section through a covering plate 3 which has grooves 36 for laying the windings of the coil conductor 25. In this case, the windings are fixed in the grooves 36 by means of an encapsulation and/or adhesive compound 38. An appropriately designed nozzle 37 is provided in order to apply the encapsulation and/or adhesive compound 38.

### LIST OF REFERENCE SYMBOLS

1 Winding device

2 Covering plate

3 Covering plate

4 Former

4a-d Formers

6 Winding axis

8 Clamping device

9 Projecting sections

10 Supporting surfaces

11 Winding device

12 Winding space

14 Covering plate

16 Cutouts

17 Central opening

19 Opening

20 Covering surface

21 Former surface

22 Winding device

24 Shaft

25 Coil conductor

26 Blind wire

27 Winding profile

28 Flat coil

30 Material cutout

32 Fastening element

34 Further coil conductor

36 Groove

37 Nozzle

38 Encapsulation compound

1. A method for producing substantially two-dimensional flat coils (28), wherein at least two covering plates (2, 3), which have a respective covering surface (20), and a former (4) with a former surface (21) which is smaller than the covering surfaces (20) are provided, wherein the former (4) is releasably clamped between the two covering plates (2, 3), so that lateral supporting surfaces (10) are formed at least in sections by projecting sections (9) of the covering plates (2, 3), wherein a coil conductor (25) is wound along the circumference of the former (4) between the covering plates (2, 3) to form the geometry of the flat coil (28), and wherein the wound coil conductors (25) are fixed locally relative to one another through cutouts (16) in at least one of the covering plates (2, 3).

2. The method as claimed in claim 1, wherein the covering plates (2, 3) are detached from one another so as to release the former (4), and wherein the locally fixed coil conductors (25) in the form of flat coils (28) are removed.

3. (canceled)

4. The method as claimed in claim 1, wherein the covering plates (2, 3) and the former (4) are mounted by means of a respective central opening (17) in a shaft (24) and are clamped to one another in the axial direction on the shaft (24).

5. (canceled)

6. The method as claimed in claim 1, wherein one end of the coil conductor (25) is routed from the inside to the outside through one of the covering plates (2, 3) through an opening (19) before the former (4) is clamped.

7. The method as claimed in claim 1, wherein a coil conductor (25) and a blind wire (26) are jointly wound radially one on the other, so that coil conductor (25) and blind wire (26) alternate in the radial direction in the flat coil (28).

8. The method as claimed in claim 1, wherein a plurality of formers (4) are clamped to one another between two covering plates (2, 3) and in a manner separated from one another by in each case one covering plate (14), and wherein a plurality of coil conductors (25) are wound onto the plurality of formers (4) at the same time to form a plurality of flat coils (28).

9. The method as claimed in claim 1, wherein at least one additional component (31), in particular a ferrite body, an electronic component and/or an electrical circuit, is inserted into at least one material cutout (30) in at least one of the covering plates (2, 3).

10. The method as claimed in claim 1, wherein the covering plates (2, 3) are permanently fixed to one another by a number of fastening elements (32).

11. The method as claimed in claim 10, wherein a further coil conductor (34) is wound at least around some of the fastening elements (32).

12. The method as claimed in claim 1, wherein the cross section of the coil conductor (25) is locally deformed before the winding operation or during the winding operation.

13. The method as claimed in claim 1, wherein the coil conductor (25) is laid in grooves (36) in at least one of the covering plates (2, 3), and is fixed there.

14. A device (1, 11, 22) for winding flat coils (28), comprising at least two covering plates (2, 3) having a respective covering surface (20), a former (4) with a former surface (21) which is smaller than the covering surface (20), and a clamping device (8) for clamping the former (4) between the two covering plates (2, 3), wherein local cutouts (16) are made in at least one of the covering plates (2, 3).

15. (canceled)

16. The device (1, 11, 22) as claimed in claim 14, wherein the covering plates (2, 3) and the former (4) each have a central opening (17) in the middle, and wherein a shaft (24) is further comprised, it being possible for the covering plates (2, 3) and the former (4) to be axially held on said shaft by way of their respective central opening (17).

17. (canceled)

18. The device (1, 11, 22) as claimed in claim 14, wherein one of the covering plates (2, 3) comprises at least one opening (19) for one end of the coil conductor (25) to pass through.

19. The device (1, 11, 22) as claimed in claim 14, wherein a plurality of the formers (4) and a plurality of the covering plates (2, 3, 14) are comprised, and wherein the clamping device (8) is designed to clamp the plurality of formers (4) between the plurality of covering plates (2, 3, 14).

20. (canceled)

21. The device (1, 11, 22) as claimed in claim 14, wherein the covering plates (2, 3) and/or the formers (4) are each provided with an anti-adhesion coating for the coil conductor (25) which is to be wound.

22. The device (1, 11, 22) as claimed in claim 14, wherein at least one material cutout (30) for holding at least one additional component (31), in particular a ferrite core, an electronic component and/or an electrical circuit, is made in at least one of the covering plates (2, 3).

23. The device (1, 11, 22) as claimed in claim 14, wherein the covering plates (2, 3) are permanently fixed by means of a number of fastening elements (32).

24. The device (1, 11, 22) as claimed in claim 23, wherein at least some of the fastening elements (32) are designed to be wound with a further coil conductor (34), in particular as rivets or as fastening pins.

25. The device (1, 11, 22) as claimed in claim 14, wherein grooves (36) for holding the coil conductor (25) are made in one of the covering plates (2, 3).
